(19) United States
(12) Patent Application Publication
(10) Pub. No.: US 2023/0149254 A1
(43) Pub. Date: May 18, 2023

(54) Roller type vagina contraction ball

(71) Applicants: Yiqun Tang, Ji'an Jiangxi (CN); Wenjie Tang, Ji'an Jiangxi (CN); Fan Wang, Huanggang (CN)

(72) Inventors: Yiqun Tang, Ji'an Jiangxi (CN); Wenjie Tang, Ji'an Jiangxi (CN); Fan Wang, Huanggang (CN)

(21) Appl. No.: 18/155,775

(22) Filed: Jan. 18, 2023

(51) Int. Cl. A61H 19/00; A61H 15/00

(52) U.S. Cl. CPC A61H 19/40; A61H 15/0078; A61H 2201/1207

(57) ABSTRACT

A vagina contraction ball includes a handle. A base is disposed at first end of the handle. A bottom end in the base is disposed with a circuit board. A motor is disposed inside the base above the circuit board. The end of the motor, away from the handle, is provided with a reduction gear box. The end of the reduction gear box away from the motor is provided with a front bearing base. Equidistant positioning shafts are disposed on an outer surface of the side of the front bearing base away from the reduction gear box. Outer surfaces of the positioning shafts are all sleeved with balls. The ends of the balls, away from the front bearing base, are provided with a front cover.

### FIELD OF THE INVENTION

The invention relates to vagina contraction balls and more particularly to a roller type vagina contraction ball.

### BACKGROUND OF THE INVENTION

A vagina contraction ball is typically known as a vagina dumbbell or a vagina yoga ball, which is placed into the female vagina for exercise, so as to enhance the sensibility and flexibility of the vagina inner surface, female sphincter and pelvic floor muscle, making an instantaneous induction like a mimosa, and then the relaxation of the vagina inner surface muscle speeds up the pleasure of orgasm. With the rapid development of science and technology, the type of the vagina contraction ball is increased day by day, and therefore a corresponding roller type vagina contraction ball has been derived.

The existing vagina contraction ball can meet the needs of users well, and is mainly provided with a handle, a front end head, a silicone case and other components. Specifically, the front end head is disposed at a front end of the handle, and the case is sleeved on an outer surface of the front end head, so as to combine and form the vagina contraction ball for users to use. According to the above description, although the vagina contraction ball can meet the needs of users to achieve the purpose of exercising and contracting the vagina, the vagina contraction ball is usually inconvenient to exercise and contract the vagina of the user in all directions, and manual operation of users is required to achieve the purpose of exercising and contracting the vagina in all directions, resulting in affecting the contracting effect of the vagina contraction ball on the vaginas of the users, and troubling the users frequently.

Thus, the need for improvement still exists.

### SUMMARY OF THE INVENTION

Therefore the purpose of the invention is to provide a roller type vagina contraction ball, so as to solve the following problems: although the vagina contraction ball proposed in the above background can meet the needs of users to achieve the purpose of exercising and contracting the vagina, the vagina contraction ball is usually inconvenient to exercise and contract vaginas of the users in all directions, and manual operation of users is required to achieve the purpose of exercising and contracting the vagina in all directions, resulting in affecting the contracting effect of the vagina contraction ball on the vaginas of the users.

In order to implement the above purpose, the invention provides the following technical solution: a roller type vagina contraction ball, including a handle, where a base is disposed at first end of the handle; a bottom end inside the base is disposed with a circuit board; a motor is disposed inside the base above the circuit board; the end, away from the handle, of the motor is provided with a reduction gear box; the end, away from the motor, of the reduction gear box is provided with a front bearing base; equidistant positioning shafts are disposed on an outer surface of one side, away from the reduction gear box, of the front bearing base; outer surfaces of the positioning shafts are all sleeved with balls; the ends, away from the front bearing base, of the balls are provided with a front cover; first end of the front cover is connected to first end of the front bearing base; a case is sleeved on an outer surface of the base, and an inner surface of the end, away from the base, of the case respectively contacts the front bearing base and an outer surface of the front cover.

Preferably, a switch is disposed at a top of the end, away from the case, of the handle, and an output end of the switch is electrically connected to an input end of the motor. The switch is disposed at a top of a rear end of the handle, so that the vagina contraction ball is convenient to be turned on and turned off.

Preferably, equidistant protrusions are disposed on an outer surface of the side, away from the handle, of the case; an angle between the adjacent protrusions is 90 degrees; and inner surfaces of the protrusions contact outer surfaces of one sides of the balls. The protrusions are equidistantly disposed on the outer surface of the case, so as to enhance frictional force between the case and the vagina inner surface, thereby improving the stimulation effect of the vagina contraction ball on the vagina.

Preferably, four groups of balls are provided, and an angle between the adjacent balls is 90 degrees. The balls are set to fit with the protrusions, so as to drive the case to rotate.

Preferably, a battery is disposed at a top of the base above the motor, and an output end of the battery is electrically connected to an input end of the circuit board. The battery is disposed at an upper end of the base, so as to perform power supply treatment on the vagina contraction ball.

Preferably, an outer surface of the side, away from the reduction gear box, of the motor is rotationally connected to an eccentric wheel. The eccentric wheel is driven to rotate when the motor runs, so that the base and the front cover can vibrate slightly, thereby achieving the purpose of vibrating and stimulating the vagina.

The invention has the following advantages and benefits in comparison with the conventional art:

The roller type vagina contraction ball can not only rub and irritate sensitive areas of the vagina automatically and in all directions to achieve the effect of contracting the vagina and exercising the vagina grip strength, thereby improving the vagina contracting effect when the vagina contraction ball is used; but also enhance the frictional force between the case and the vagina inner surface to further improve the stimulating effect of the vagina contraction ball on the vagina, thereby achieving the purpose of vibrating and stimulating the vagina.

The motor drives the front bearing base to rotate slowly through the reduction gear box to make the front bearing base drive the front cover to slowly rotate through the positioning shafts and the balls in turn, so that when rotating, the front cover and the front bearing base drive the case to rotate slowly through the balls, and sensitive areas of the vagina can be rubbed and irritated automatically and in all directions, so as to achieve the effect of contracting the vagina and exercising the vagina grip strength, thereby improving the vagina contracting effect when the vagina contraction ball is used.

A plurality of protrusions are equidistantly disposed on the outer surface of the case, and the balls are disposed inside the protrusions for supporting and limiting the protrusions, so as to enhance the frictional force between the case and the vagina inner surface, thereby further improving the stimulating effect of the vagina contraction ball on the vagina.

The eccentric wheel is driven to rotate when the motor runs, so that the base and the front cover can vibrate slightly, thereby achieving the purpose of vibrating and stimulating the vagina.

The above and other objects, features and advantages of the invention will become apparent from the following detailed description taken with the accompanying drawings

### BRIEF DESCRIPTION OF THE DRAWINGS

FIG. 1 is a perspective view of a roller type vagina contraction ball according to the invention;

FIG. 2 is a side elevation of the roller type vagina contraction ball in FIG. 1;

FIG. 3 is a top plan view of the roller type vagina contraction ball in FIG. 1; and

FIG. 4 is an exploded view of the roller type vagina contraction ball in

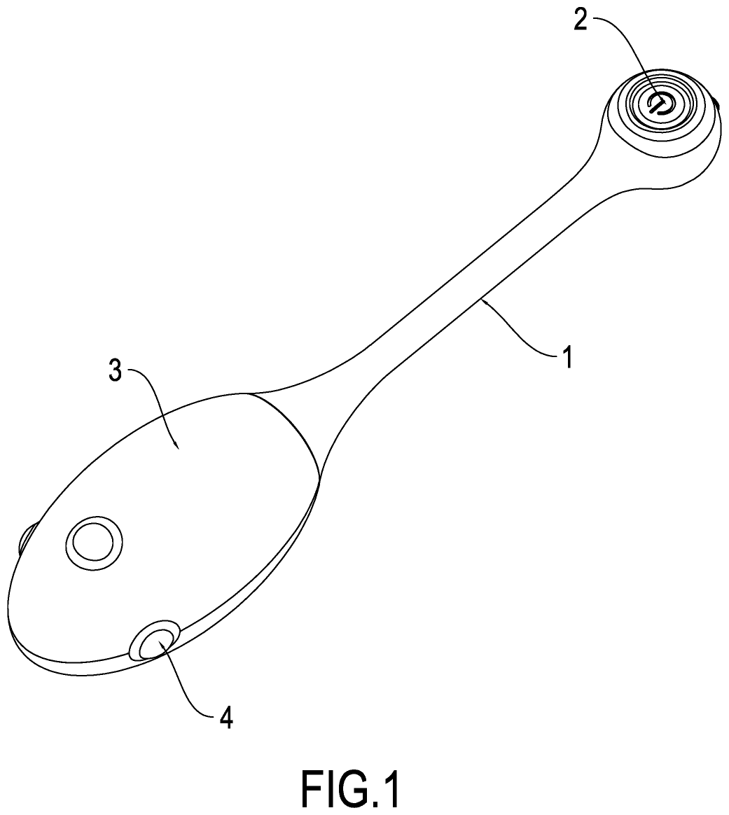

FIG. 1.

### DETAILED DESCRIPTION OF THE INVENTION

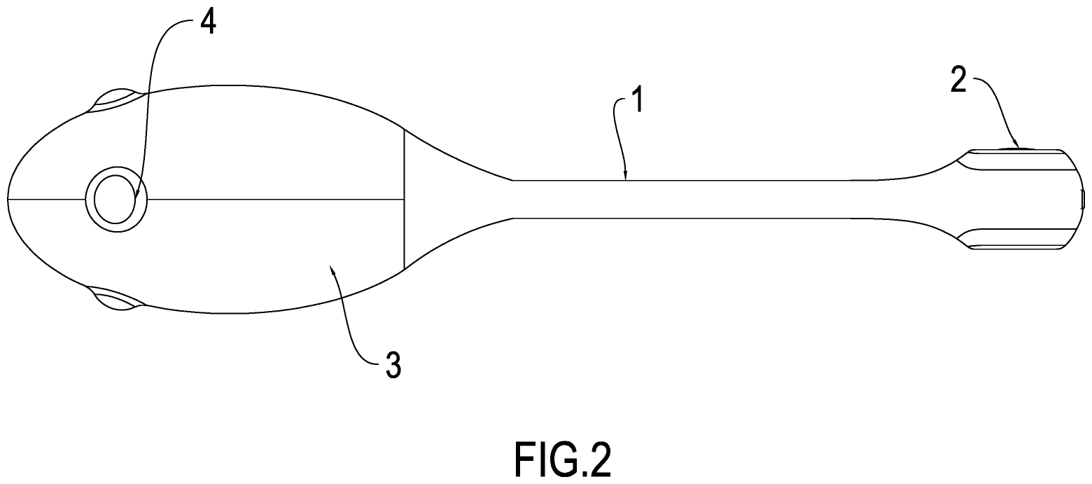

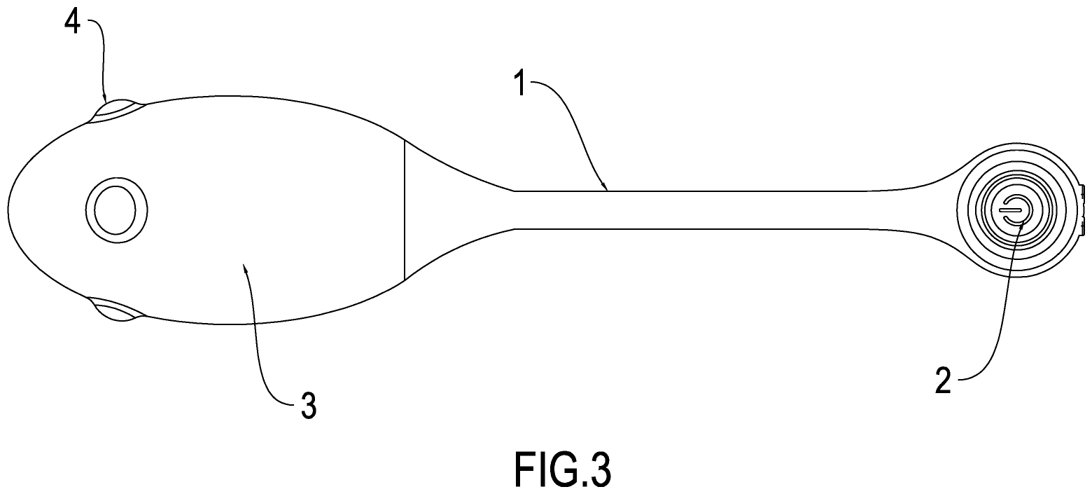

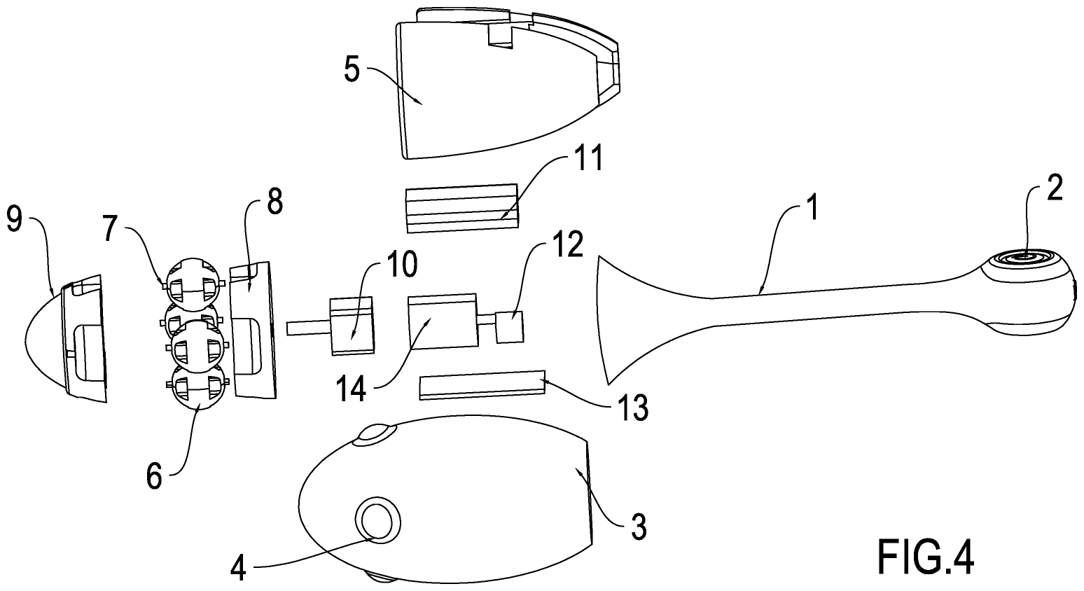

Referring to FIGS. 1 to 4, a roller type vagina contraction ball of the invention is provided and detailed below. The roller type vagina contraction ball comprises a handle 1, where a switch 2 is disposed at a top of the end, away from a housing 3, of the handle 1, and an output end of the switch 2 is electrically connected to an input end of the motor 14.

During use, the switch 2 is disposed at a top of a rear end of the handle 1, so that the vagina contraction ball is convenient to be turned on and turned off.

A base 5 is disposed at first end of the handle 1, a bottom end inside the base 5 is disposed with a circuit board 13, a motor 14 is disposed inside the base 5 above the circuit board 13, a battery 11 is disposed at a top of the base 5 above the motor 14, and an output end of the battery 11 is electrically connected to an input end of the circuit board 13.

During use, the battery 11 is disposed at an upper end of the base 5, so as to perform power supply treatment on the vagina contraction ball.

An outer surface of the side, away from the reduction gear box 10, of the motor 14 is rotationally connected to an eccentric wheel 12.

During use, the eccentric wheel 12 is driven to rotate when the motor 14 runs, so that the base 5 and the front cover 9 can vibrate slightly, thereby achieving the purpose of vibrating and stimulating the vagina.

The end, away from the handle 1, of the motor 14 is provided with a reduction gear box 10; the end, away from the motor 14, of the reduction gear box 10 is provided with a front bearing base 8; equidistant positioning shafts 7 are disposed on an outer surface of the side, away from the reduction gear box 10, of the front bearing base 8; outer surfaces of the positioning shafts 7 are all sleeved with balls 6; four groups of balls 6 are provided, and an angle between the adjacent balls 6 is 90 degrees.

During use, the balls 6 are set to fit with the protrusions 4, so as to drive the housing 3 to rotate.

The ends, away from the front bearing base 8, of the balls 6 are provided with a front cover 9, and first end of the front cover 9 is connected to first end of the front bearing base 8.

The housing 3 is sleeved on an outer surface of the base 5, and an inner surface of the end, away from the base 5, of the housing 3 respectively contacts the front bearing base 8 and the outer surface of the front cover 9.

Equidistant protrusions 4 are disposed on an outer surface of the side, away from the handle 1, of the housing 3; an angle between the adjacent protrusions 4 is 90 degrees; and inner surfaces of the protrusions 4 contact outer surfaces of one sides of the balls 6.

During use, the protrusions 4 are equidistantly disposed on the outer surface of the housing 3, so as to enhance frictional force between the housing 3 and the vagina inner surface, thereby improving the stimulating effect of the vagina contraction ball on the vagina.

During the use of the invention, the motor 14 first drives the front bearing base 8 to rotate slowly through the reduction gear box 10 to make the front bearing base 8 drive the front cover 9 to slowly rotate through the positioning shafts 7 and the balls 6 in turn, so that when rotating, the front cover 9 and the front bearing base 8 drive the housing 3 to rotate slowly through the balls 6, and sensitive areas of the vagina can be rubbed and irritated automatically and in all directions, so as to achieve the purpose of contracting the vagina and exercising the vagina grip strength; afterwards, a plurality of groups of protrusions 4 are equidistantly disposed on the outer surface of the housing 3, and the balls 6 disposed inside the protrusions 4 support and limit the protrusions 4, so as to enhance the frictional force between the housing 3 and the vagina inner surface, thereby further improving the stimulating effect of the vagina contraction ball on the vagina; and finally, the eccentric wheel 12 is driven to rotate when the motor 14 runs, so that the base 5 and the front cover 9 can vibrate slightly, thereby achieving the purpose of vibrating and stimulating the vagina. In addition, the vagina contraction ball may also be used to massage the male prostate, so as to achieve the effect of assisting rehabilitation massage and physiotherapy, thereby completing the use of the vagina contraction ball.

While the invention has been described in terms of preferred embodiments, those skilled in the art will recognize that the invention can be practiced with modifications within the spirit and scope of the appended claims.

What is claimed is:

1. A roller type vagina contraction ball, comprising:
a handle including a base at a first end;
a circuit board disposed on a bottom end of the base;
a motor disposed in the base above the circuit board;
a reduction gear box disposed at a first end of the motor distal the handle;
a front bearing base disposed at a first end of the reduction gear box distal the motor;
a plurality of equidistant positioning shafts disposed on an outer surface of the front bearing base distal the reduction gear box;
a plurality of balls fitted over the positioning shafts;
a front cover disposed at first ends of the balls distal the front bearing base wherein a first end of the front cover is connected to a first end of the front bearing base; and
a housing fitted over the base;
wherein an inner surface of a first end of the housing distal the base contacts the front bearing base and an outer surface of the front cover respectively.

2. The roller type vagina contraction ball of claim 1, further comprising a switch disposed on a top of a second end of the handle distal the housing wherein the switch is electrically connected to the motor.

3. The roller type vagina contraction ball of claim 1, further comprising a plurality of equidistant protrusions disposed on an outer surface of the housing distal the handle wherein an angle between any two adjacent ones of the protrusions is 90-degree and inner surfaces of the protrusions contact outer surfaces of the balls.

4. The roller type vagina contraction ball of claim 1, wherein the balls comprise four groups and an angle between two adjacent ones of the balls is 90-degree.

5. The roller type vagina contraction ball of claim 1, further comprising a battery disposed on a top of the base above the motor wherein the battery is electrically connected to the circuit board.

6. The roller type vagina contraction ball of claim 1, further comprising an eccentric wheel rotatably connected to an outer surface of the motor distal the reduction gear box.
